(19) United States
(12) Patent Application Publication
(10) Pub. No.: US 2004/0006664 A1
(43) Pub. Date: Jan. 8, 2004

(54) System and method for efficient chip select expansion

(76) Inventors: Amir Helzer, Nesher (IL); Andrew Buchan, Cambridge (GB)

Correspondence Address: Kevin T. Duncan, Esq., Hunton & Williams, Intellectual Property Department, 1900 K Street, N.W., Suite 1200, Washington, DC, 20006, US

(21) Appl. No.: 10/186,663

(22) Filed: Jul. 2, 2002

(51) Int. Cl. G06F 12/00

(52) U.S. Cl. 711/5

(57) ABSTRACT

A chip select circuit is based on a multiplexed bus having a chip select phase, an address phase, and a data phase. During the chip select phase, a chip select latch receives chip select signals from the multiplexed bus at one input and a chip select enable signal at a second input. The chip select latch has a plurality of outputs to the chip select inputs of a plurality of connected devices. Based on the chip select signals from the multiplexed bus, one of the plurality of outputs enables a selected connected device. During the address phase, an address latch receives address signals from the multiplexed bus at a first input and an address enable signal at a second inputs. The output of the address latch passes the address signals to the address inputs of the plurality of connected devices. The chip select circuit is operative to used the multiplexed bus to select one of the connected devices using the single chip select enable signal without requiring further enabling/control signals.

### FIELD OF THE INVENTION

The present invention relates generally to chip selection operations, and more particularly, to a system and method for allowing multiple devices to be connected to a chip with fewer pins.

### BACKGROUND OF THE INVENTION

Typical central processor unit (CPU) systems have to interface to multiple devices, such as to input/output (I/O) devices or external peripheral devices. These external devices may include flash memory devices, read-only memory devices (ROM), random access memory devices (RAM), universal asynchronous receiver/transmitter (UART) devices, application specific integrated circuits (ASICs), timer devices, other microprocessors, direct memory access channels (DMAs), hard disks, tape drives, CD-ROMs, user interfaces, display devices, printers, and so forth.

For example, FIG. 1 illustrates a basic microcomputer or microprocessor having a CPU, main memory, and I/O section. As illustrated in FIG. 2, the I/O section may include input and output multiplexers that select the I/O devices. These input and output multiplexers are sometimes referred to as “data selectors” because they select which I/O devices are going to provide data to the CPU or are going to receive data from the CPU. The I/O register and the output buffers in FIG. 2 provides temporary storage during the transmission of data between the CPU and the output devices, and between the output multiplexer and output devices, respectively.

FIG. 3 is another block diagram of a typical computer system. The computer system includes the CPU subsystem, a memory subsystem, and an I/O subsystem. The direct memory access (DMA) provides a link between a peripheral controller (not shown) in the I/O subsystem and the memory subsystem to permit data from peripherals to be read/written from/to the memory subsystem without CPU intervention. The CPU communicates with the memory subsystem over a memory bus that typically includes: (1) an address bus (to allow the CPU to place an address to be read from/written to in memory), (2) a data bus (to allow the CPU to place data that is to be read from/written to at the address), and (3) control lines (to allow the CPU to define the action that is to be taken, such as a read or a write).

Continuing with FIG. 3, the CPU communicates with the I/O subsystem over the I/O bus. Generally, the processor writes and reads information to/from the external devices (peripherals) using special I/O instructions that place commands and data on the I/O bus. Like the memory bus, the I/O bus typically includes the components (1)-(3) discussed above, i.e., there are: (1) address lines (to allow the CPU to select among different I/O devices connected to the system), (2) I/O data lines (to allow the CPU to exchange data with the I/O devices), and (3) control lines (to allow the CPU to define the action that is taken). The control data may include such things as read/write access signals and chip select signals.

FIG. 4 illustrates the interface between the CPU and the I/O subsystem over the I/O bus in further detail. As shown in FIG. 4, the CPU interfaces with the external I/O devices over the I/O bus (which includes the I/O data, address, and the control lines) that permits the selection of one of the plurality of I/O devices that can be supported for a given CPU system. Access to the I/O bus by the CPU/peripherals is controlled by a bus controller (not shown) that is part of the CPU and that is coupled to “selection lines” that enable/disable the peripherals.

Generally, CPU systems will have “chip select” circuitry coupled to a finite number of selection lines that can support connecting the system to a finite number of I/O devices. For example, the selection lines may be part of the control lines depicted in FIG. 4. General background on chip select circuits is provided in McIntyre, Jr., et al., U.S. Pat. No. 5,875,482, and Circello, et al., U.S. Pat. No. 5,872,940.

Connecting several devices to a bus on a CPU system usually requires a separate available I/O interface, and consequently, a separate pin, for each external device. In other words, a separate selection output line is required for each device. One common problem is that if many devices are connected to the bus, the number of selection lines may be too large for the system. This limits the potential applications for the CPU system.

Accordingly, CPU system designers face a dilemma at design time. If too few selection lines are built in, the CPU system will be unable to support enough external devices. If too many selection lines are built in, the CPU system will have too many pins and the designer will have wasted valuable “real estate.” It is difficult for designers to predict future applications for a CPU system, and in many cases a suboptimal number of chip selection lines are designed into the CPU system. This can be a significant problem.

Several approaches for overcoming the limitation of dedicated chip selection lines have been proposed. For example, Estakhri, et al., U.S. Pat. No. 5,818,350, entitled “High Performance Method of and System for Selecting One of a Plurality of IC CHIP[s] While Requiring Minimal Select Lines,” discloses several approaches for a bus controller to select one of a plurality of IC chips using minimal select lines. In a first approach using address lines as chip enable lines, Estakhri proposes using a plurality of paired address lines whereby a selected one of the lines of each pair is coupled to a given IC chip. Thus, each IC chip is coupled to a unique combination of the selected lines of the pairs. Whereas coupling 32 memory devices to a controller would normally require 32 chip select lines, this first approach would only require 10 lines from the chip select address bus. This approach suffers the disadvantages of requiring an n-input AND gate for each device and somewhat complex wiring.

In a second approach also using address lines as chip enable lines, Estakhri multiplexes the chip select and address functions over a single bus. A chip select signal is applied to the correct address line and then several control signals are required to select a particular device. Estakhri's second approach allows connection of a number of devices up to the number of address lines.

In a third disclosed approach, Estakhri provides for the controller to clock a select signal from one of the ICs to the next in a manner similar to a shift register. Once the select signal is present in the desired IC, the controller issues an enable signal in parallel to all ICs which enables only the desired IC.

In yet another approach, Estakhri provides for storing a unique value in each IC also having a comparator. When the controller places the unique value onto the data bus to select a given IC, that IC's comparator determines that it has been selected and then responds to a chip select signal issued by the controller.

Yoon, et al., U.S. Pat. No. 5,677,877, entitled “Integrated Circuit Chips with Multiplexed Input/Output Pads and Methods of Operating Same,” proposes that the usual limitation that n input/output pads (pins) provides access to only n signal lines in a memory IC can be overcome by multiplexing such that any input/output pad can access any signal line, thus effectively expanding the number of pins. The capability is implemented using selection control circuits that issue select signals for allowing a given pin to select a particular signal line. Yoon indicates that this approach would allow three physical pins to enjoy a total of seven different connections to the IC (instead of the usual three), thus allowing a fewer number of pins to maintain the same I/O capability.

Kobayashi, U.S. Pat. No. 5,568,647, entitled “Serial Control Apparatus with a Single Chip Select Signal,” proposes a serial control apparatus for controlling ICs on a plurality of printed circuit cards such that increasing the number of ICs on a card does not increase the number of signal lines for selecting the ICs. The CPU selects an IC by generating serial identification signals including a card ID signal and an IC ID signal.

Each of the aforementioned attempts to mitigate the problem of limited selection lines, but suffers disadvantages and limitations that make them not fully satisfactory.

### SUMMARY OF THE INVENTION

An embodiment of the present invention comprises a chip select circuit based on a multiplexed bus having a chip select phase, an address phase, and a data phase. During the chip select phase, a chip select latch receives chip select signals from the multiplexed bus at one input and a chip select enable signal at a second input. The chip select latch has a plurality of outputs to the chip select inputs of a plurality of connected devices. Based on the chip select signals from the multiplexed bus, one of the plurality of outputs enables a selected connected device. During the address phase, an address latch receives address signals from the multiplexed bus at a first input and an address enable signal at a second input. The output of the address latch passes the address signals to the address inputs of the plurality of connected devices. The chip select circuit is operative to use the multiplexed bus to select one of the connected devices using the single chip select enable signal without requiring further enabling/control signals.

According to another aspect of the invention, a CPU system is provided including a controller, a plurality of connected devices, and a device select circuit. The device select circuit includes a multiplexed bus having a chip select phase, an address phase, and a data phase. The device select circuit also includes a first controllable storage means for transferring chip select information from the multiplexed bus during the chip select phase to chip enable inputs of the connected devices, and a second controllable storage means for transferring address information from the multiplexed bus during the address phase to the address inputs of the connected devices. The CPU system allows one of the connected devices to be selected based on the chip select information and a single chip select enable signal.

Accordingly, it is one object of the present invention to overcome one or more of the aforementioned and other limitations of existing systems and methods for connecting CPU systems to peripheral devices.

Another object of the invention is to provide a system and method for connecting CPU systems to peripheral devices that allows the connection of many I/O devices using fewer I/O pins.

Another object of the invention is to provide a system and method for connecting CPU systems to peripheral devices that eliminates the need for having a separate selection output line for each connected I/O device.

Another object of the invention is to provide a system and method for connecting CPU systems to peripheral devices so that the bus controller does not have to maintain dedicated selection lines.

Another object of the invention is to provide a system and method for connecting CPU systems to peripheral devices using selection information that is multiplexed with address and data so that a single selection line can be shared among multiple I/O devices.

The accompanying drawings are included to provide a further understanding of the invention and are incorporated in and constitute part of this specification, illustrate several embodiments of the invention and, together with the description, serve to explain the principles of the invention. It will become apparent from the drawings and detailed description that other objects, advantages and benefits of the invention also exist.

Additional features and advantages of the invention will be set forth in the description that follows, and in part will be apparent from the description, or may be learned by practice of the invention. The objectives and other advantages of the invention will be realized and attained by the system and methods, particularly pointed out in the written description and claims hereof as well as the appended drawings.

### BRIEF DESCRIPTION OF THE DRAWINGS

The purpose and advantages of the present invention will be apparent to those of skill in the art from the following detailed description in conjunction with the appended drawings in which like reference characters are used to indicate like elements, and in which:

FIG. 1 is a diagram of a basic microcomputer or microprocessor having a CPU, main memory, and I/O section.

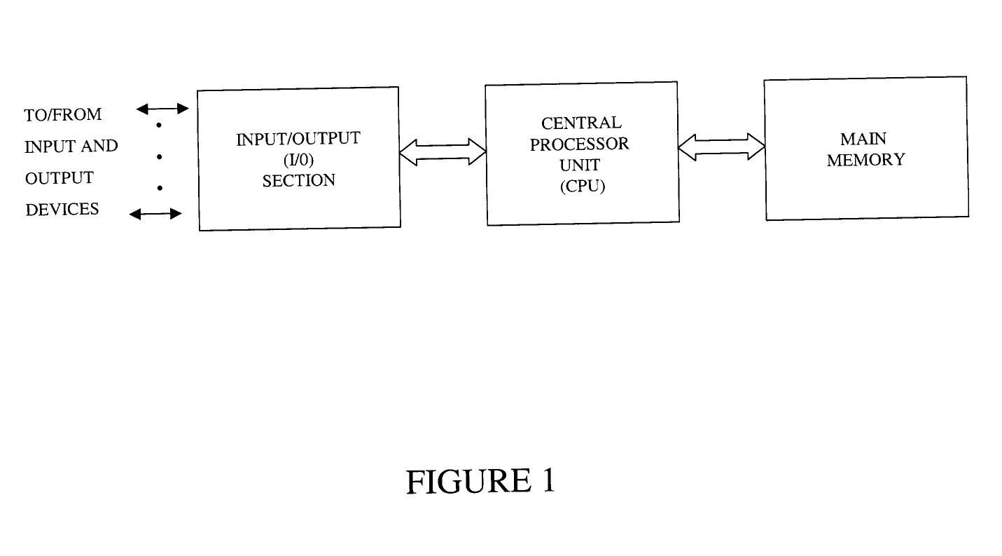

FIG. 2 is a diagram of an exemplary input/output subsystem of a basic microcomputer or microprocessor.

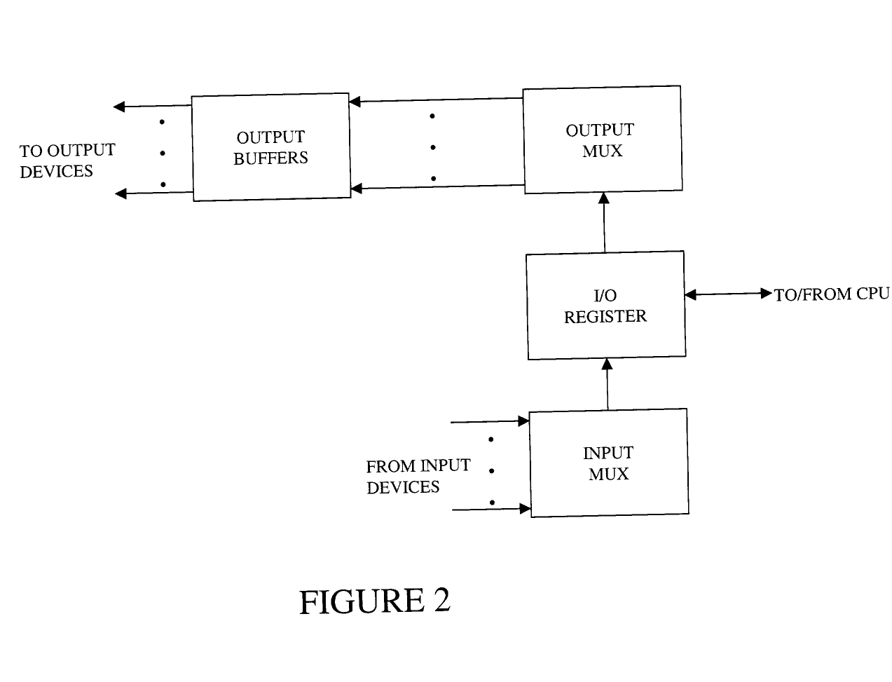

FIG. 3 is a diagram of a basic computer system having a CPU subsystem, memory subsystem, input/output subsystem, and associated busses.

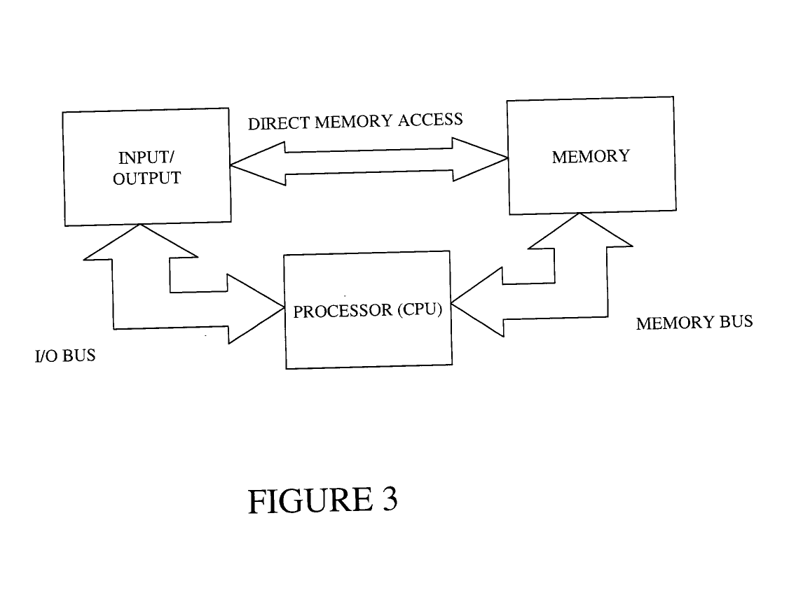

FIG. 4 is a diagram of a basic computer system including further details on the input/output subsystem and the input/output bus.

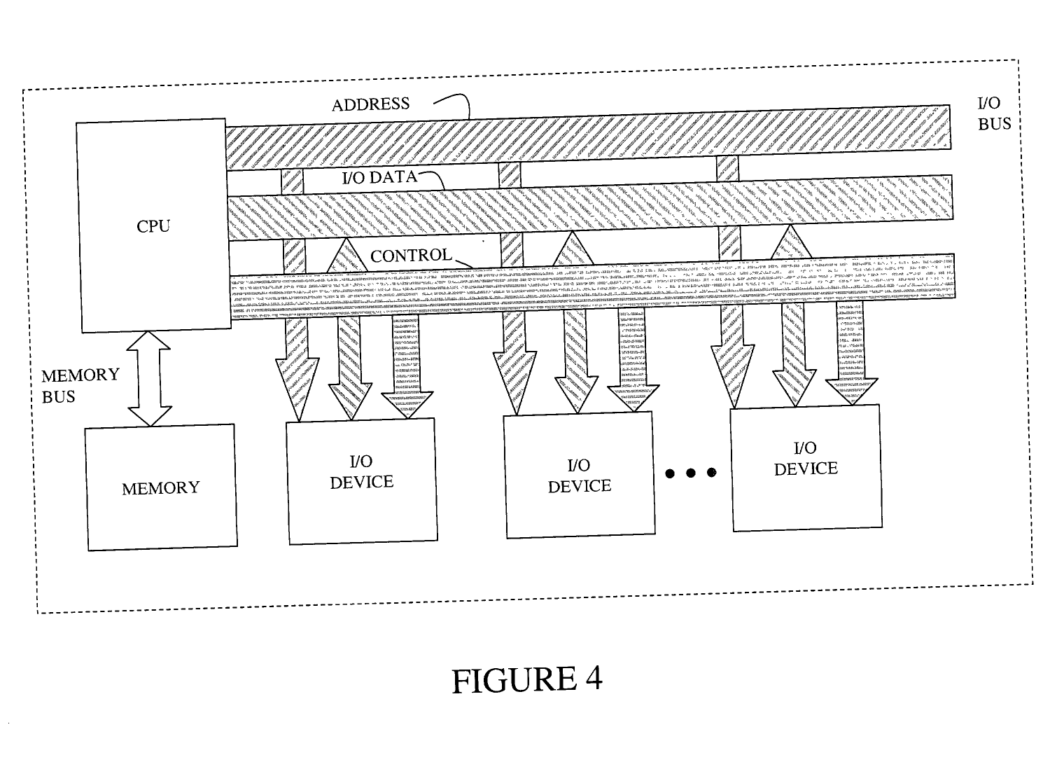

FIG. 5 is a diagram of a system for sharing selection lines among a plurality of devices according to an embodiment of the invention.

FIG. 6 is an exemplary timing diagram corresponding to a system for sharing selection lines among a plurality of devices according to an embodiment of the invention.

### DETAILED DESCRIPTION OF THE INVENTION

Generally, the invention relates to a system and method for sharing selection output lines in a CPU system so that the bus controller does not maintain dedicated selection lines. In other words, multiple I/O devices can share selection lines, which enables the connection of many I/O devices with fewer pins. Generally, the invention may be implemented into any CPU system having pins for connection to external devices such as peripherals. For example, the invention can be incorporated into a microprocessor, microcontroller, or memory chip. According to one embodiment, the invention is implemented into a high performance communications processor (HPCP) system-on-a-chip (SOC), such as that disclosed in U.S. Provisional Application No. 60/347,235, entitled “High Performance Communications Processor Supporting Multiple Communications Applications,” which was filed on Jan. 14, 2003, and which is herein incorporated by reference in its entirety. According to one embodiment, the invention is implemented in the HPCP referred to as the “Trajan” in the aforementioned application.

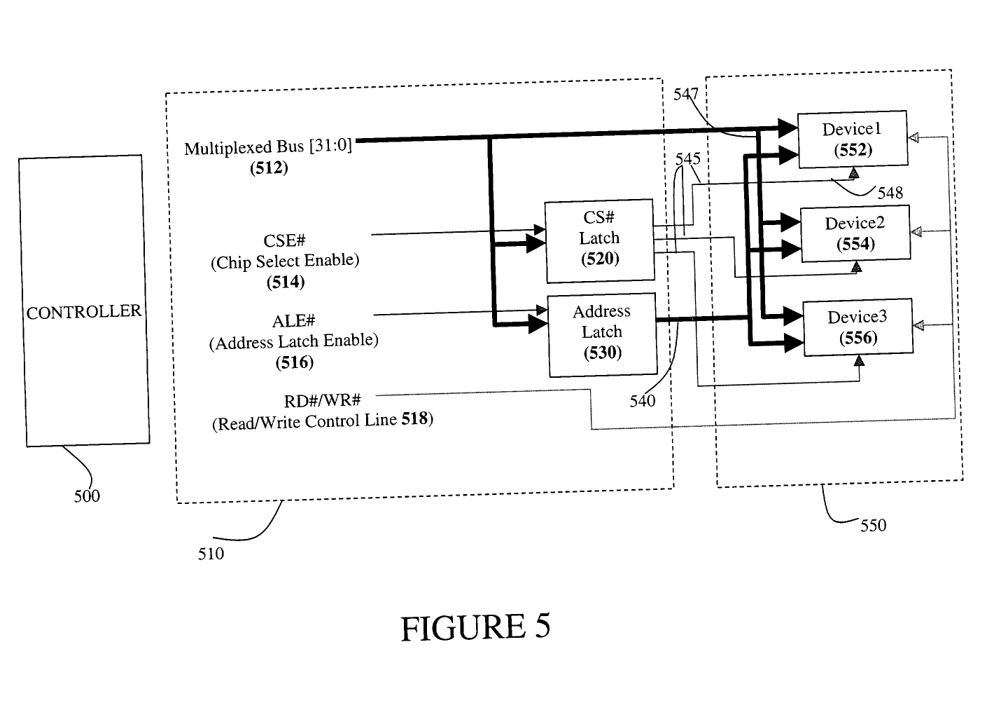

FIG. 5 is a diagram of CPU system allowing multiple devices can be connected without dedicated selection lines according to an embodiment of the invention. FIG. 5 includes controller 500, device select circuitry 510, and external devices 550. Controller 500 may comprise any device capable of controlling access to a bus by external devices connected to a chip. Preferably, controller 500 is a bus controller operatively connected to a CPU or integrated with a CPU core.

External devices 550 comprises a plurality of devices, such as I/O devices or peripherals, that may be connected to a bus shared with other external devices and that is controlled by controller 500. For example, external devices may comprise one or more of the following: flash memory devices, read-only memory devices (ROM), random access memory devices (RAM), universal asynchronous receiver/transmitter (UART) devices, application specific integrated circuits (ASICs), timer devices, other microprocessors, direct memory access channels (DMAs), hard disks, tape drives, CD-ROMs, user interfaces, display devices, printers, and so forth. External devices 550 may share the same or have differing bus protocols.

Device selection circuitry 510 is circuitry that permits a plurality n external devices 550 to access a bus under the control of controller 500 whereby the n external devices share a selection line that is not dedicated. Sharing of the selection line is allowed by multiplexing the bus so that it supports three functions or phases: a chip select phase, an address phase, and a data phase. Thus, the multiplexing involves the multiplexing of the chip select signals along with the address and data signals. This approach permits each selection line to support a number of connected devices as wide as the length of the bus (i.e., the address). Thus, for a 32 bit wide address a single selection line can support 32 devices, two selection lines can support 64 devices, and so forth. If the address is 64 bits wide, a single selection line can support 64 devices, two selection lines can support 128 devices, and so forth.

FIG. 5 is an embodiment of the invention including a single shared select line that can be shared among up to 32 devices for the 32 bit multiplexed bus 512. FIG. 5 is provided only as an example in order to clearly explain the invention. A greater number of shared selection lines (e.g., 2, 3, etc.) could be provided for the CPU system, and/or a different bus width (e.g., 16 bit, 64 bit, etc.) could be employed without departing from the spirit and scope of the present invention.

According to one embodiment, the CPU system of FIG. 5 may be provided with the signaling to support the chip select feature of the invention. For example, the CPU system may comprise a chip (e.g., a microprocessor, a microcontroller, a specialized DSP, a communications processor, etc.) having signaling (e.g., multiplexed bus 512, CSE 514, ALE 516, and RD/WR 518) that enables the chip select function. When a user wishes to connect external devices to the chip, only the latch hardware (e.g., latches 520 and 530) need to be added by the user. In other words, the logic/signals for driving the latches are already present, and the user need not add shift registers and/or elaborate decoding logic as is required in certain prior art approaches to the problem.

According to another embodiment, the CPU system may include the aforementioned signaling and also have the address latching built into the CPU system. Therefore, the user connecting further devices does not need to add the address latch; rather, the user need only add the external chip select latch (e.g., CS latch 520).

According to yet another embodiment, the CPU system includes both dedicated chip select lines (not shown in FIG. 5) and the latched chip select lines (FIG. 5) of the present invention. This mixed approach provides maximum flexibility by providing dedicated chip select lines for quick access cycles for time-critical external devices, while allowing the connection of other, less critical devices to the latched chip select lines. For example, CPU system may be a communication processor having 4 dedicated chip select lines (supporting 4 external devices) and 1 latched chip select line (supporting up to 32 latched devices).

According to one embodiment, device select circuitry 510 includes multiplexed bus 512, chip select enable line 514, address latch enable line 516, read/write control line(s) 518, chip select latch 520, address latch 530, latched address bus 540, and latched select lines 545. Multiplexed bus 512 comprises a multiplexed bus of the address, chip select, and data.

Chip select enable 514, address latch enable 516, and read/write control line 518 are control lines that control CS latch 520, address latch 530, and external devices 510, respectively.

CS latch 520 and address latch 530 may comprise any suitable latch devices capable of latching device1 552, device2 554, and device3 556. Generally, a latch has a data input, a latch enable input (e.g., clock input), and a latch data output. Referring to FIG. 5, when the chip select enable 514 is activated, CS latch 520 allows chip select signals from the chip select phase to be output via latched select lines 545 to the chip select inputs of the three devices. CS latch 520 outputs these chip select signals based on the chip select data carried on multiplexed bus 512 during the chip select phase. When the address latch enable 516 is activated, address latch 530 allows the address data to be output on the latched address bus 540 accessible by the three devices. This output from latch 530 is based on the address data carried on the multiplexed bus 512 during the address phase.

The operation of the CPU system of FIG. 5 is now described for an exemplary access. First, the chip select phase commences. Chip select data is placed on multiplexed bus 512. For example, for a 32 bit bus the chip selection data may be 00000000 00000000 00000000 00000001 (hereinafter, *1) indicating that the first device 512 is to be selected for this access. Next, chip select enable 514 issues an enabling signal (e.g., a pulse) that activates latch 520. Activating latch 520 allows the latch to respond to the chip select data by issuing chip select signals along latched selection lines 545 based on the chip select data. Latched chip select lines 545 will place all of the devices 552-556 in the disabled state except for the selected device. In the above example, chip select data *1 causes only latch chip select line 548 to be enabled.

Second, the address phase commences. Address data is placed on multiplexed bus 512. Next, address latch enable 516 issues an enabling signal that activates latch 530. Activating latch 530 allows the latch to pass the address data on latched address bus 540 to each of the devices 552-556.

Third, the data phase commences. If a write is to be performed, data is placed on multiplexed bus 512. Next, control line 518 issues a control signal to enable a write to the latched address at the selected device (*1). If a read is to be performed, control line 518 issues a control signal to enable a read operation for the selected device to place data from the latched address onto the bus 512 for controller 500 to read.

In an optional fourth phase, the selected device can be deselected during an optional chip deselect phase. In this phase, deselecting chip select data (i.e., 0 . . . 0}is placed on bus 512 indicating that all devices are to be deselected. Chip select enable 514 issues an enabling signal that activates latch 520 and causes all devices to be disabled.

The optional fourth phase may be included to reduce current draw and simply as a matter of good engineering practice. However, the fourth phase can easily be excluded because in the first phase of the next access a previously-selected device will be deselected. Also, the ordering of the chip select and address phases can easily be switched so that the ordering is address phase, chip select phase, and data phase.

The effect of the approach taken by the system in FIG. 5 is that a single select line has been multiplexed or shared among three output devices. The single select line is not dedicated to a particular device. The engineering tradeoff is that access speed decreases because of the additional clock cycles. For noncritical devices that are accessed less frequently, this approach provides additional capability for the CPU system without entailing additional pins.

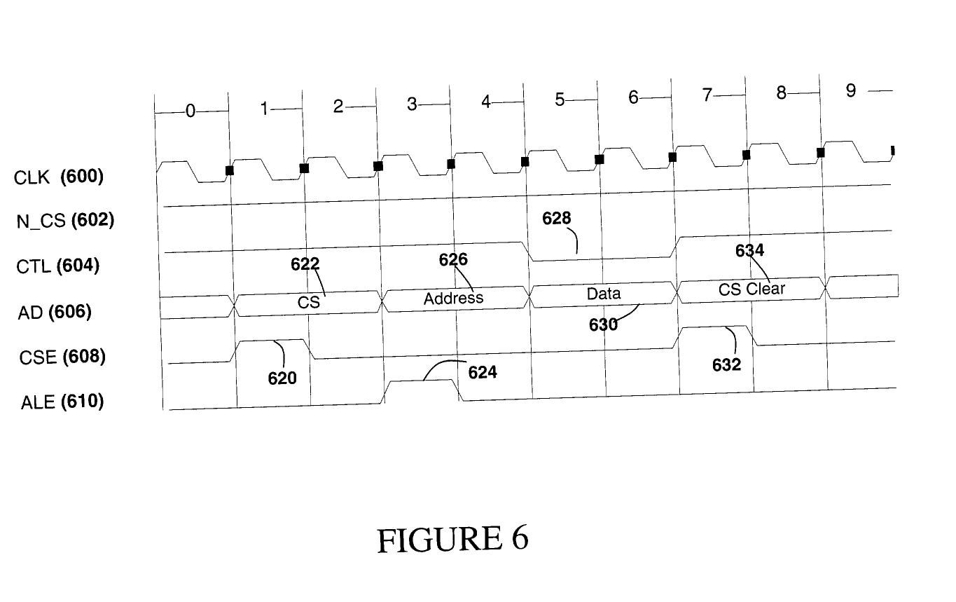

FIG. 6 is an exemplary timeline according to one method for implementing a shared select line for a plurality of external devices. FIG. 6 includes the timing for the following: CLK 600 (bus clock); N_CS 602 (dedicated chip select lines); CTL 604 (control signals, e.g., reads or writes); AD 606 (the multiplexed bus); CSE 608 (chip select enable); and ALE 610 (address latch enable).

One cycle of an access using the shared select line according is now described according to FIG. 6. During the first phase, CSE 608 latches the chip select mode at 620 and the chip select data from the multiplexed address bus AD 606 is read at 622. In the second phase, ALE 610 latches the address data at 624 and the address data from multiplexed address bus AD 606 is read at 626. In the third phase, CTL 604 enables an operation (e.g., a read or write) at 628 and the data is read to/from the multiplexed address bus AD 606 at 630. In an optional fourth phase, CSE 608 latches the chip select mode at 632 and the chip select data (0 . . . 0) from multiplexed address bus AD 606 is read at 634, disabling each of the devices.

N_CS 602 is included for completeness to indicate that there may also be dedicated select lines that are used to access devices in the usual manner.

As shown in FIG. 6, the exemplary embodiment has a run time of 8 clock cycles. Four of these clock cycles (corresponding to 622 and 634) are used for controlling the external CS latches (e.g., CSE 520 of FIG. 5).

In an alternative embodiment of the invention, rather than multiplexing all of the address, chip select, and data onto a single bus (as shown in FIGS. 5-6), the address and chip select information could be multiplexed onto a first set of lines, while the data could be carried on a second set of lines. According to this approach, the first set of lines would have two or three phases. For example, the first set of lines could have a first chip select phase and a second address phase (the timing of the phases can be reversed). Or the first set of lines could have a first chip select phase, a second address phase, and a third chip deselect phase (the timing of the first and second phases can be reversed). Regarding the second set of lines, these would carry the data. According to this alternative embodiment, a 32 line bus (such as that shown in FIG. 5) could be used in the chip select mode as follows: 24 lines for chip select/address (or chip select/address/chip deselect) and 8 lines for data. The tradeoff in this alternative embodiment, of course, is that fewer external devices (24) can be connected than in the other embodiment (32).

Other embodiments and uses of this invention will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

What is claimed is:

1. A chip selection circuit, comprising:
a multiplexed bus having a data phase, an address phase, and a chip select phase;
a chip select latch having a first input for receiving signals from the multiplexed bus, a second input for receiving a chip select enable signal, and a plurality of outputs to the chip select inputs of a plurality of connected devices; and
an address latch having a first input for receiving signals from the multiplexed bus, a second input for receiving an address enable signal, and an output of the multiplexed bus to the plurality of connected devices.
wherein the chip selection circuit is operative to select one of the plurality of connected devices based on a single enable signal comprising the chip select enable signal.

2. The chip selection circuit of claim 1, wherein three cycles are performed for an operation accessing a selected device through the multiplexed bus, the three cycles comprising a chip select cycle, an address cycle, and a data cycle.

3. The chip selection circuit of claim 1, wherein four cycles are performed for an operation accessing a selected device through the multiplexed bus, the four cycles comprising a chip select cycle, an address cycle, a data cycle, and a deselect cycle.

4. A CPU system for sharing a select line, comprising:
a controller; and
a device select circuit including:
a multiplexed bus including a chip select phase, an address phase, and a data phase;
first controllable storage means for transferring chip select information from the multiplexed bus during the chip select phase to chip enable inputs of a plurality of connected devices;
second controllable storage means for transferring address information from the multiplexed bus during the address phase to address inputs of the plurality of connected devices;
wherein one of said plurality of connected devices is selected based on said device select circuit receiving signals consisting of the chip select information from the multiplexed bus and a single enable signal.

5. The CPU system of claim 4, wherein said first and second controllable storage means comprise latches.

6. The CPU system of claim 4, wherein the multiplexed bus further comprises a deselect phase.

7. The CPU system of claim 4, further comprising a plurality of dedicated select lines coupled to said controller, thereby providing a CPU system supporting dedicated and non-dedicated select lines.

8. A chip select circuit, comprising:
means for controlling access to a multiplexed bus having a chip select phase, an address phase, and a data phase;
means for providing an address during an address phase;
means for selecting one of a plurality of devices during a chip select phase; wherein said means for selecting enables the selected device in response to data consisting of chip select information carried on the multiplexed bus and a single chip enable signal.

9. The chip select circuit of claim 8, wherein said means for providing an address comprises an address latch with a first input for receiving an address enable signal, a second input for receiving address information from the multiplexed bus, and an output providing the address information from the multiplexed bus to the address inputs of the plurality of devices.

10. The chip select circuit of claim 8, wherein said means for selecting comprises a chip enable latch with a first input for receiving the single chip enable signal; a second input for receiving the chip select information carried on the multiplexed bus, and an output providing the chip select information to the chip select inputs of the plurality of devices.

11. The chip select circuit of claim 10, wherein said multiplexed bus further comprises a deselect phase.
